(19) United States
(12) Patent Application Publication
(10) Pub. No.: US 2007/0082698 A1
(43) Pub. Date: Apr. 12, 2007

(54) CARRIER SEARCH METHODS AND RELATED DEVICES

(75) Inventor: Yu-Li Su, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: MEDIATEK INC., Hsin-Chu (TW)

(21) Appl. No.: 11/459,690

(22) Filed: Jul. 25, 2006

Related U.S. Application Data
(60) Provisional application No. 60/724,210, filed on Oct. 6, 2005.

(51) Int. Cl. H04Q 7/20

(52) U.S. Cl. 455/552.1; 455/435.2; 455/434; 370/910; 370/445

(57) ABSTRACT

The present invention relates to a carrier search method and a related device, and in particular relates to a carrier search method and a related device excluding overlapping bands from being searched in active mode to reduce the power consumption. A carrier search method is utilized in a mobile station. The mobile station operates in a plurality of supported modes, and each mode comprises a plurality of supported bands. The mobile station is in a mobile communication system comprising a plurality of cells. The carrier search method comprises: receiving a carrier search request to search network in an active mode; excluding overlapping bands from being searched in the active mode that are already utilized by inactive modes; searching RF channels in non-excluded bands in the active mode, wherein the active mode is a currently-utilized mode providing network service and the other modes are the inactive modes.

### CROSS REFERENCE TO RELATED APPILCATIONS

This application is related and co-pended with U.S. patent application Ser. No. 11/159,849, filed Jun. 23, 2005 and entitled “CARRIER SEARCH METHODS AND RELATED DEVICES”.

### BACKGROUND OF THE INVENTION

1. Field of the Invention

The present invention relates to a carrier search method and a related device, and in particular relates to a carrier search method and a related device excluding overlapping bands from being searched in active mode to reduce the power consumption.

2. Description of the Related Art

A multi-band and multi-mode mobile station (e.g. multi-band and multi-mode mobile telephone) can operate in all supported modes (e.g. GSM, WCDMA, CDMA2000) and supported bands (e.g. 850, 900, 1800, 1900, band (a), band (b), . . . ). When searching for a network or selecting a cell to camp on, the multi-band mobile station performs a carrier search to search all RF (radio frequency) channels within all supported bands. This, however, wastes too much power, especially since not all supported bands for one specific mode are useful/available.

### BRIEF SUMMARY OF THE INVENTION

A detailed description is given in the following embodiments with reference to the accompanying drawings.

A carrier search method is utilized in a mobile station. The mobile station operates in a plurality of supported modes, and each mode comprises a plurality of supported bands. The mobile station is in a mobile communication system comprising a plurality of cells. The carrier search method comprises: receiving a carrier search request to search network in an active mode; excluding overlapping bands from being searched in the active mode that are already utilized by inactive modes; searching RF channels in bands not-excluded in the active mode. The active mode is a current-utilized mode and the other modes are the inactive modes.

### BRIEF DESCRIPTION OF THE DRAWINGS

The present invention can be more fully understood by reading the subsequent detailed description and examples with references made to the accompanying drawings, wherein:

FIG. 1 is a schematic diagram showing the band arrangements in different modes;

FIG. 2 is a flowchart illustrating a power-efficient carrier search method according to an embodiment of the invention;

FIG. 3 is a schematic diagram of a mobile station according to the present invention;

FIG. 4 is a flowchart illustrating the band-used information sharing method in dual modes according to an embodiment of the invention;

FIG. 5 is a flowchart illustrating the band-used information sharing method in dual modes according to another embodiment of the invention;

FIG. 6 is a schematic diagram of a mobile station according to the present invention;

FIG. 7 is a flowchart illustrating the band-used information sharing method in dual modes according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

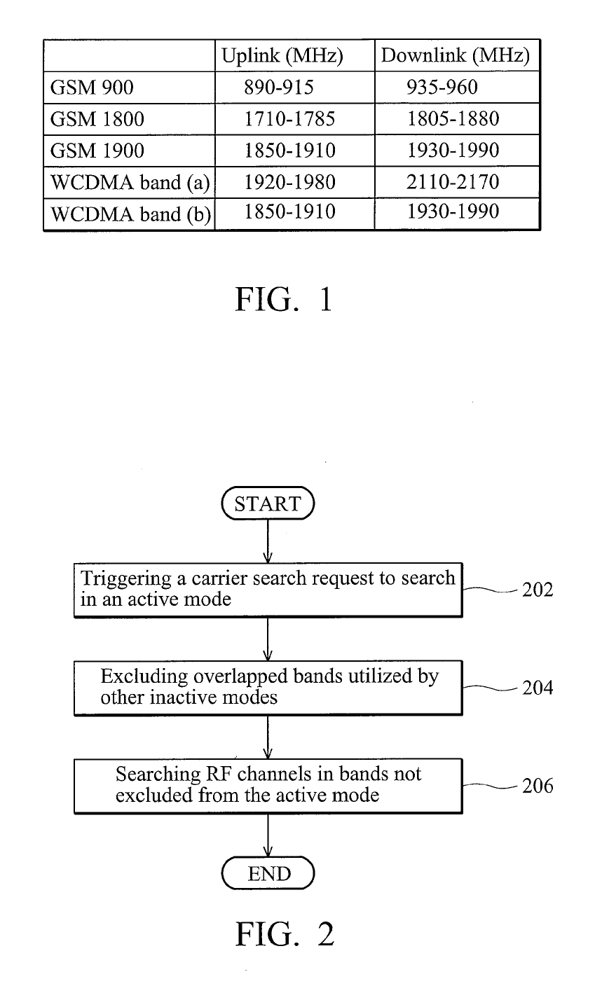

Please refer to FIG. 1. FIG. 1 is a schematic diagram showing the band arrangements (uplink and downlink) in different modes (taking modes GSM and WCDMA for example). In the case of GSM (Global System for Mobile Communications), different bands (e.g. band 900, band 1800, band 1900) may be utilized, and each band has its own uplink and downlink ranges. For example, in band 900, the uplink range is from 890 to 915 (MHz) and the downlink is from 935 to 960 (MHz). Similarly, in the WCDMA (Wideband Code Division Multiple Access) case, different bands (e.g. band (a) and band (b)) may be utilized, and each band has its own uplink and downlink ranges. In band (a), the uplink range is from 1920 to 1980 (MHz) and the downlink is from 2110 to 2170 (MHz); in band (b), the uplink range is from 1850 to 1910 (MHz) and the downlink is from 1930 to 1990 (MHz). It can be observed that some band arrangements overlap (partially or totally) for different modes. As shown in FIG. 1, band (b) in WCDMA and 1900 in GSM partially overlap. However, only one mode can utilize the overlapping bands in practice. For example, if one country (or area) already utilizes band (b) to provide services in mode WCDMA, it will choose band 900 or band 1800 to provide services in GSM mode rather than band 1900 since band (b) and band 1900 overlap. Therefore, while carrier searching in a current active mode (the currently-utilized mode), the mobile station can reduce power consumption by excluding search for some overlapping bands that are utilized in other (inactive) modes. A detailed description of carrier searching is provided in the following.

Please refer to FIG. 2. FIG. 2 is a flowchart illustrating a power-efficient carrier search method according to an embodiment of the invention. Initially, a carrier search request (for a PLMN search or a cell selection) is triggered for network search on supported bands in an active mode (step 202). If some overlapping bands are utilized in other (inactive) modes, these bands are excluded in the active mode (step 204). The mobile station searches for RF channels in bands which are not excluded in the active mode to achieve efficient power consumption (step 206). Additionally, each mode may have corresponding band-used information to store band usage, and band-used information for different modes can be shared to find out the bands which should be excluded in a specific mode. Some methods of sharing band-used information in multi-modes are provided in the following (taking dual modes as examples, mode A and mode B utilize the band-used information INFO_A and INFO_B to store the band usage, respectively).

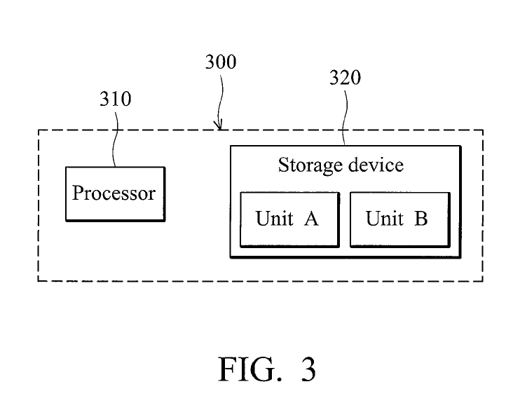

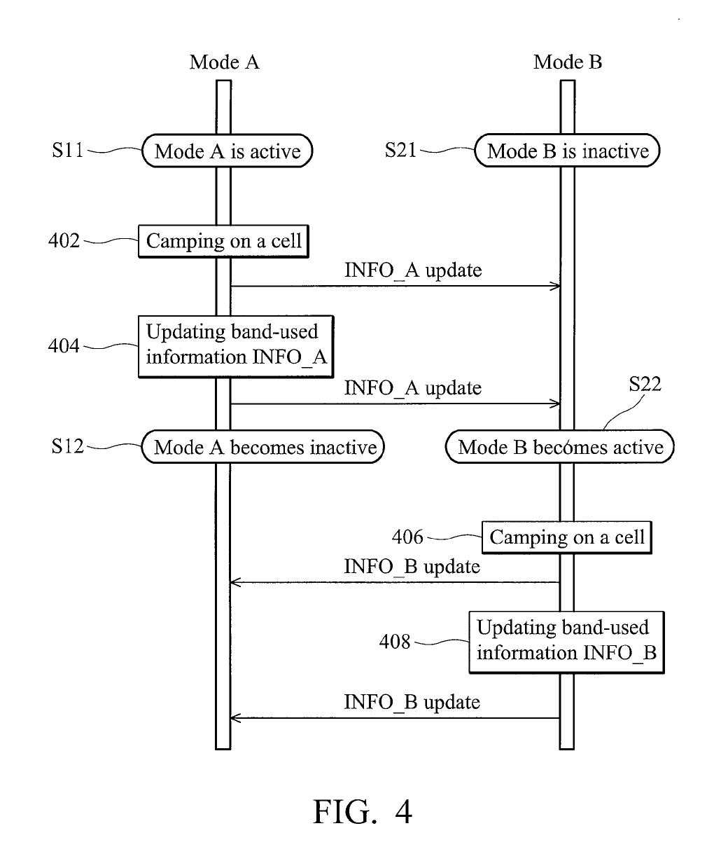

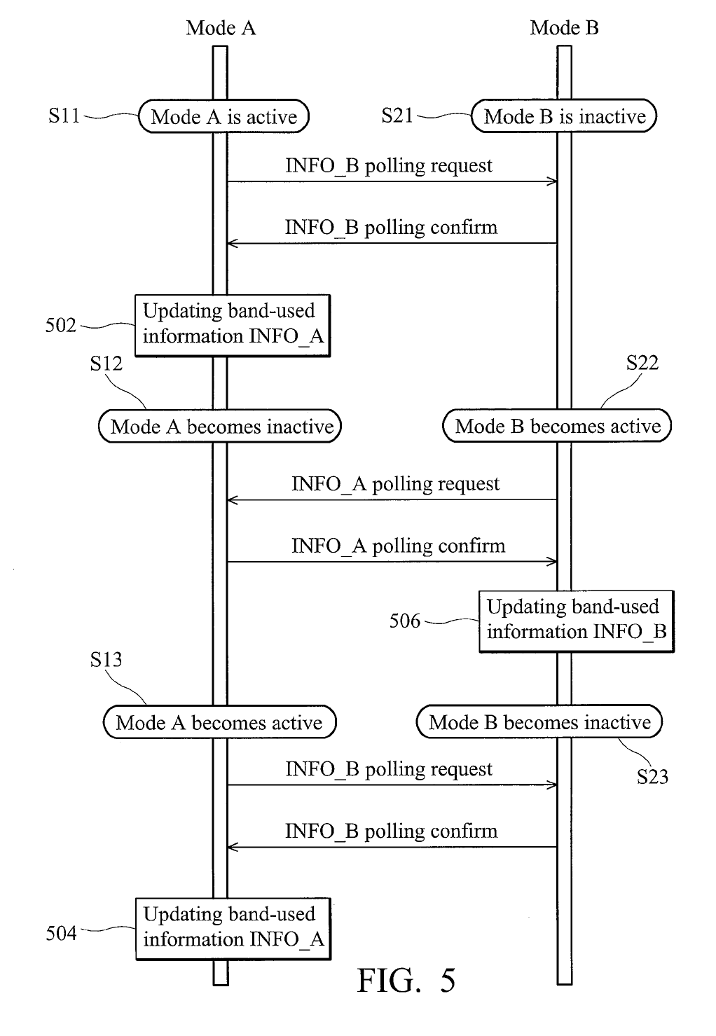

Please refer to FIG. 3. FIG. 3 is a schematic diagram of a mobile station 300 according to the present invention. The mobile station 300 comprises a processor 310 and a storage device 320. The processor 310 performs a plurality of tasks, including tasks A and B, to control the operation of the mobile station 300. The storage device 320 further comprises units A and B. The unit A stores the band-used information INFO_A for mode A while the unit B stores the band-used information INFO_B for mode B. Please note that only task A can access storage unit A where band-used information INFO_A is stored while only task B can access storage unit B where band-used information INFO_B is stored. In other words, the band-used information INFO_A and INFO_B can not be shared with each other directly. The band-used information INFO_A and INFO_B may be shared by actively signaling (see FIG. 4) or by polling (see FIG. 5).

Please refer to FIG. 3 and FIG. 4 at the same time. FIG. 4 is a flowchart illustrating a band-used information sharing method in dual modes according to an embodiment of the invention. Assume that mode A is active (state S11) and mode B (state S21) is inactive initially. When mode A is active, processor 310 uses task A for performing telecommunication operations. Task A refers to the band-used information INFO_A for network search. After the mobile station 300 camps on a cell (step 402), task A will update band-used information INFO_A if there is a need, and task A will actively send the updated band-used information INFO_A to task B (please see the first arrow in FIG. 4). Then, task B will compare the updated band-used information INFO_A and the band-used information INFO_B to find out the overlapping bands and update the band-used information INFO_B accordingly by removing the overlapping ones.

Every time the band-used information INFO_A changes (step 404), task A again sends its band-used information INFO_A to the task B (please see the second arrow in FIG. 4). Hence task B always knows the latest band-used information INFO_A from task A. The task B refers to the latest band-used information INFO_A to find out overlapping bands and update the band-used information INFO_B accordingly by removing the overlapping ones. Once the mode states change (for example, from state S11 to state S12, from state S21 to state S22), the processor 310 utilizes another task (task B) to perform telecommunication operations and camps on another cell (step 406). Similarly, in the case in which mode B is active, the task B refers to the band-used information INFO_B to search bands in the mode B, camps on the cell in mode B (step 406), and actively sends its band-used information INFO_B to the task A (please see the third arrow in FIG. 4), and actively re-sends the latest band-used information INFO_B if the band-used information INFO_B changes (step 408 and the fourth arrow in FIG. 4). An example is given in the following.

For example, in a country utilizing dual modes, assume that the mode A is GSM utilizing band 900 and band 1800 to provide services and mode B is WCDMA utilizing band (a) to provide services. Initially, mode GSM is active (S11) and mode WCDMA is inactive (S21). The task A searches RF channels in all possible bands (900, 1800, and 1900) in mode GSM, camps on the cell in mode GSM to provide services (step 402), updates the band-used information INFO_A to store the currently utilized bands 900 and 1800, and actively sends the updated band-used information INFO_A to the task B. Then, task B will compare the updated band-used information INFO_A (comprising bands 900 and 1800) and the band-used information INFO_B (comprising bands (a) and (b)) to find out the overlapping bands and update the band-used information INFO_B accordingly by removing the overlapping ones. In this moment, task B does not find out overlapping bands between mode GSM and mode WCDMA. After a period of time, the mobile station 300 moves to another cell in mode WCDMA to provide services and the mode states change (mode GSM becomes inactive in state S12 and mode WCDMA becomes active in state S22). In this moment (step 406), if there are overlapping bands already found out in previous steps (steps 402 and 404), the task B does not need to search all possible bands (band (a) and band(b)) in mode WCDMA to reduce power consumption; otherwise, all possible bands in mode WCDMA must be searched. In the case in which mode WCDMA is active, the task B can not reduce power consumption since there are no overlapping bands in the band-used information INFO_A (comprising bands 900 and 1800) and all possible bands (bands (a) and (b)) in the active mode WCDMA. However, next time when the mode GSM becomes active (not shown in FIG. 4), the task A can find an overlapping band (band 1900) between all possible bands (band 900, 1800, 1900) in the active mode GSM and the band-used information INFO_B (band(a), band (b)) for the inactive mode WCDMA and exclude the overlapping band being searched so as to reduce power consumption. Another band-used information sharing method (by polling) is provided in the following.

Please refer to FIG. 3 and FIG. 5 at the same time. FIG. 5 is a flowchart illustrating the band-used information sharing method in dual modes according to another embodiment of the invention. When mode A is active (mode A is in state S11 or state S13 while mode B is in state S21 or state S23), the processor 310 uses task A for performing telecommunication operations. Task A will send a polling request (see the first or fifth arrows in FIG. 5) to task B for band-used information INFO_B. Then, task B accesses the storage unit B and sends the band-used information INFO_B to task A (see the second and sixth arrows in FIG. 5). Task A then compares the band-used information INFO_A (accessed from the unit A) with the band-used information INFO_B to find out the overlapping bands. Then task A updates the band-used information INFO_A accordingly by removing the overlapping bands (steps 502 or 504). Next, task A refers to the updated band-used information INFO_A for network search. After mobile station camps on a cell, task A will further update the band-used information INFO_A if there is a need. After a period of time, when mode B becomes active (mode A enters state S12 while mode B enters state S22), the processor 310 uses task B for performing telecommunication operations. Similarly, task B sends a polling request (see the third arrow in FIG. 5) to task A for band-used information INFO_A and find out the overlapping bands. Compared with the previous embodiment (in FIG. 4) where the band-used information is shared by actively signaling (the task corresponding to active mode actively sends its band-used information to another task), in this embodiment, the band-used information is shared by polling (the task corresponding to active mode sends a polling request to ask for the band-used information of another task) In other words, the task corresponding to currently-active mode obtains the band-used information corresponding to another task in a previous state where the currently-active mode is inactive in the previous embodiment while the task corresponding to currently-active mode obtains the band-used information corresponding to another task in the current state in this embodiment. For example, in the country utilizing dual modes (as described in the previous embodiment), after the task A corresponding to active mode GSM sends a polling request, the task A can obtain the band-used information INFO_B corresponding to task B. However, in the previous embodiment, the task A corresponding to active mode GSM obtains the band-used information INFO_B corresponding to the task B when the mode GSM is inactive. Another band-used information sharing method (by a shared memory) is provided in the following.

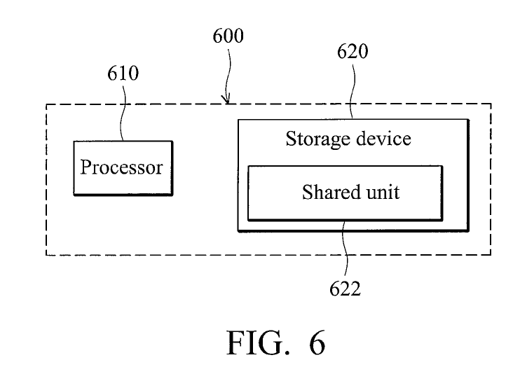

Please refer to FIG. 6. FIG. 6 is a schematic diagram of a mobile station 600 according to the present invention. The mobile station 600 comprises a processor 610 and a storage device 620. The processor 610 performs a plurality of tasks, including tasks A and B, to control the operations of the mobile station 600. The storage device 620 further comprises a shared unit 622. The shared unit 622 stores the band-used information INFO_A and INFO_B for modes A and B. Task A is capable of reading the band-used information INFO_A and B, but only can update the band-used information INFO_A. Similarly, task B is capable of reading the band-used information INFO_A and B, but only can update the band-used information INFO_B. A detailed description of band-used information sharing via the shared unit is provided in the following.

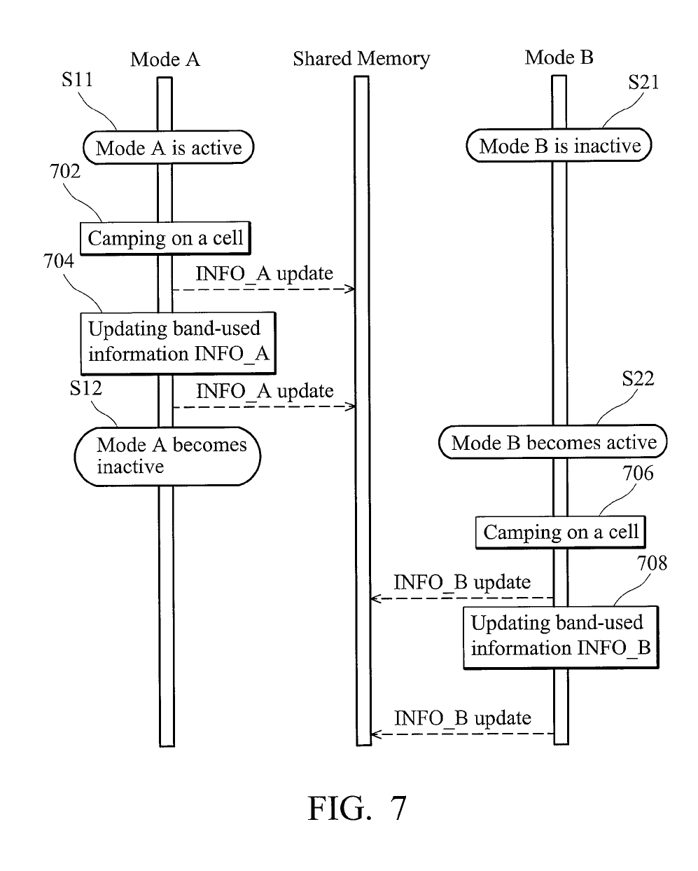

Please refer to FIG. 6 and FIG. 7 at the same time. FIG. 7 is a flowchart illustrating the band-used information sharing method in dual modes according to another embodiment of the invention. When mode A is active (mode A is in state S11 while mode B is in state S21), the processor 610 uses task A for performing telecommunication operations (see the step 702 fin FIG. 7). Task A first compares band-used information INFO_A and band-used information INFO_B stored in the shared unit 622 to find out the overlapping bands and update the band-used information INFO_A accordingly by removing the overlapping ones (see the first arrow in FIG. 7). Task A will then refer to the band-used information INFO_A for network search. After mobile station successfully camps on a cell, task A will update band-used information INFO_A if there is a need (see the step 704 and the second arrow in FIG. 7). Next, when mode B is active (mode A is in state S12 while mode B is in state S22), the processor 610 uses task B for performing telecommunication operations (see the step 706 fin FIG. 7). Task B firstly compares band-used information INFO_A and B to find out the overlapping bands and update the band-used information INFO_B accordingly by removing the overlapping ones. Task B will then refer to the band-used information INFO_B for network search. After the mobile station 600 successfully camps on a cell, task B will update band-used information INFO_B if there is a need (see the step 708 and the fourth arrow in FIG. 7).

Compared with the related art, the power-efficient carrier search method of the invention can exclude overlapping bands from being searched in the active mode and only search the non-excluded (non-overlapped) bands to reduce power consumption. Additionally, the band-used information sharing methods of the invention are utilized to make band-used information for different modes shared and hence the active mode can determine whether overlapping bands exist according to the shared band-used information.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A carrier search method utilized in a mobile station, said mobile station operating in a plurality of supported modes, and each mode comprising a plurality of supported bands, said mobile station being in a mobile communication system, and said mobile communication system comprising a plurality of cells, comprising:
receiving a carrier search request to search network in an active mode;
excluding overlapping bands from being searched in the active mode that are already utilized by inactive modes; and
searching RF channels in non-excluded bands in the active mode;
wherein the active mode is a currently-utilized mode providing network service and the other modes are the inactive modes.

2. The method as claimed in claim 1 further comprising:
utilizing a plurality of tasks to control the operation of the mobile station in the plurality of supported modes, respectively;
wherein an active task is a currently-utilized task for currently controlling the mobile station in the active mode while the other tasks are inactive tasks corresponding to the inactive modes.

3. The method as claimed in claim 2, wherein the step of excluding overlapping bands further comprises:
comparing the band-used information for the active mode and that for the other modes to determine the overlapping bands.

4. The method as claimed in claim 3, wherein the step of comparing the band-used information further comprises:
utilizing the active task to obtain band-used information for the active mode directly;
utilizing the active task to send polling requests to the inactive tasks to ask for band-used information for the inactive modes;
utilizing the active task to compare the band-used information for the active mode and that for the inactive modes to determine the overlapping bands; and
utilizing the active task to update band-used information for the active mode accordingly by removing the overlapping bands
wherein the mobile station performs the network search by using the updated band-used information.

5. The method as claimed in claim 3, wherein the step of comparing the band-used information further comprises:
utilizing the active task to actively send the band-used information for the active mode to the inactive tasks;
utilizing a first task of the inactive tasks to obtain band-used information for a first mode of the inactive mode directly when the first mode becomes active and the active mode becomes inactive;
utilizing the first task to compare the band-used information for the first modes and that for the previously active mode to determine the overlapping bands; and
utilizing the first task to update band-used information for the first mode accordingly by removing the overlapping bands;
wherein the mobile station performs the network search by using the updated band-used information.

6. The method as claimed in claim 3, wherein the step of comparing the band-used information further comprises:
utilizing the active task to obtain band-used information for the active mode and that for the inactive modes directly, wherein the band-used information for the active mode and for the inactive modes are stored in a shared memory;
utilizing the active task to compare the band-used information for the active mode and that for the inactive modes to determine the overlapping bands; and
utilizing the active task to update band-used information for the active mode accordingly by removing the overlapping bands;
wherein the mobile station performs the network search by using the updated band-used information.

7. A mobile station, said mobile station operating in a plurality of supported modes, each mode comprising a plurality of supported bands, said mobile station being in a mobile communication system, and said mobile communication system comprising a plurality of cells, comprising:
means for receiving a carrier search request to search network in an active mode;
means for excluding overlapping bands from being searched in the active mode that are already utilized by inactive modes; and
means for searching RF channels in non-excluded bands in the active mode;
wherein the active mode is a currently-utilized mode providing network service and the other modes are the inactive modes.

8. The mobile station as claimed in claim 7 further comprising:
means for utilizing a plurality of tasks to control the operation of the mobile station in the plurality of supported modes, respectively;
wherein an active task is a currently-utilized task for currently controlling the mobile station in the active mode while the other tasks are inactive tasks corresponding to the inactive modes.

9. The mobile station as claimed in claim 8 further comprising:
means for comparing the band-used information for the active mode and that for the other modes to determine the overlapping bands.

10. The mobile station as claimed in claim 9, wherein the means for comparing the band-used information further comprises:
means for utilizing the active task to obtain band-used information for the active mode directly;
means for utilizing the active task to send polling requests to the inactive tasks to ask for band-used information of the inactive modes;
means for utilizing the active task to compare the band-used information for the active mode and that for the inactive mode to determine the overlapping bands; and
means for utilizing the active task to update band-used information for the active mode accordingly by removing the overlapping bands;
wherein the mobile station performs the network search by using the updated band-used information.

11. The mobile station as claimed in claim 9, wherein the means for comparing the band-used information further comprises:
means for utilizing the active task to actively sending the band-used information for the active mode to the inactive tasks;
means for utilizing a first task of the inactive tasks to obtain band-used information for a first mode of the inactive modes directly when the first mode becomes active and the active mode becomes inactive;
means for utilizing the first task to compare the band-used information for the first mode and that for the previously active mode to determine the overlapping bands; and
means for utilizing the first task to update band-used information for the first mode accordingly by removing the overlapping bands;
wherein the mobile station performs the network search by using the updated band-used information.

12. The mobile station as claimed in claim 9 further comprising:
means for utilizing the active task to obtain band-used information for the active mode and that for the inactive modes directly, wherein the band-used information for the active mode and for the inactive modes are stored in a shared memory;
means for utilizing the active task to compare the band-used information for the active mode and that for the inactive modes to determine the overlapping bands; and
means for utilizing the active task to update band-used information for the active mode accordingly by removing the overlapping bands;
wherein the mobile station performs the network search by using the updated band-used information.

13. A mobile station, said mobile station operating in a plurality of supported modes, each mode comprising a plurality of supported bands, said mobile station being in a mobile communication system, and said mobile communication system comprising a plurality of cells, comprising:
a processor for performing a plurality of tasks to control the operation of the mobile station, wherein each of the plurality of tasks is corresponding to one of the plurality of supported modes, and when the mobile station operates in one of the plurality of supported modes, the corresponding task is utilized to control the operation of the mobile station; and
a storage device for storing band-used information for each of the plurality of modes;
wherein an active mode is a currently-utilized mode providing network service and the other modes are the inactive modes; the active task is a currently-utilized task for currently controlling the mobile station in the active mode while the other tasks are inactive tasks corresponding to the inactive modes;
wherein the processor performs:
receiving a carrier search request to search network in the active mode;
excluding overlapping bands from being searched in the active mode that are already utilized by inactive modes; and
searching RF channels in non-excluded bands in the active mode.

14. The mobile station as claimed in claim 13, wherein the processor further compares the band-used information for the active mode and that for the other modes to determine the overlapping bands.

15. The mobile station as claimed in claim 14, wherein the storage device further comprises:
an active memory unit for storing band-used information for the active mode; and
a plurality of inactive memory units for storing band-used information for the inactive modes.

16. The mobile station as claimed in claim 15, wherein the processor further performs:
utilizing the active task to obtain band-used information for the active mode directly;
utilizing the active task sending polling requests to the inactive tasks to ask for band-used information for the inactive modes; and
utilizing the active task comparing the band-used information for the active mode and that for the inactive modes to determine the overlapping bands; and
utilizing the active task to update band-used information for the active mode accordingly by removing the overlapping bands;
wherein the mobile station performs the network search by using the updated band-used information.

17. The mobile station as claimed in claim 15, wherein the processor further performs:
utilizing the active task to actively send the band-used information for the active mode to the inactive tasks;
utilizing a first task of the inactive tasks to obtain band-used information for a first mode of the inactive modes directly when the first mode becomes active and the active mode becomes inactive;
utilizing the first task to compare the band-used information for the first mode and that for the previously active mode to determine the overlapping bands; and
utilizing the first task to update band-used information for the first mode accordingly by removing the overlapping bands;
wherein the mobile station performs the network search by using the updated band-used information.

18. The mobile station as claimed in claim 14, wherein the storage device further comprises:
a shared unit for storing band-used information of the active mode and the inactive modes.

19. The mobile station as claimed in claim 18, wherein the processor further performs:
utilizing the active task to obtain band-used information for the active mode and that for the inactive modes from the shared unit directly;
utilizing the active task to compare the band-used information for the active mode and that for the inactive modes to determine the overlapping bands; and
utilizing the active task to update band-used information for the active mode accordingly by removing the overlapping bands;
wherein the mobile station performs the network search by using the updated band-used information.
